(19) United States
(12) Patent Application Publication
(10) Pub. No.: US 2007/0133432 A1
(43) Pub. Date: Jun. 14, 2007

(54) Methods and system for measuring the round trip time in packet switching telecommunication networks

(75) Inventors: Giuseppe De Noia, Torino (IT); Maurizio Beoni, Torino (IT); Andrea Roasio, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TELECOM ITALIA S.P.A., 20123 MOLANO, ITALY (IT)

(21) Appl. No.: 10/580,440

(22) PCT Filed: Nov. 27, 2003
(86) PCT No.: PCT/EP03/13357

§ 371 Date: May 24, 2006

(51) Int. Cl. H04L 12/26

(52) U.S. Cl. 370/253

(57) ABSTRACT

A method and related system measure the round trip time in the communication of packets between ports of a packet switching communication network in which, among other packets, report packets, like RTCP packets of the SR type, are transmitted by transmitting ports to destination ports in response to previous packets received from said respective destination ports by the steps of (a) detecting at any point of the network, among the packet traffic flowing therethrough, a first report packet transmitted by a first port to a second port and a second report packet responsive to said first report packet; (b) computing the round trip time between the first and second ports as a function of the report packet transmission time and delay data reported in the second report packet and of the previous report transmission time and delay data reported in the first report packet.

### TECHNICAL FIELD

The present invention refers to managing packet communication in packet switching communication networks. In particular, the present invention refers to a method and related system for measuring the round trip time (“RTT”) in the distribution of packets based upon Internet standard protocols, like Real-time Transport Protocol (“RTP”) and associated Real-Time Control Protocol (“RTCP”) and for managing the network communications on the basis of such RTT measurements.

### BACKGROUND ART

The specifications of RTP and RTCP are described in the Internet Standard Request For Comments (RFC) 1889 issued on Jan. 1, 1996 (“RFC 1889”).

RTP provides end-to-end network transport functions suitable for applications transmitting real-time data, such as audio, video or simulation data, over multicast or unicast network services for real-time services. The companion RTCP is based on the periodic transmission of control packets to all participants in a communication session, using the same distribution mechanism as the data packets. The primary function of RTCP packets is to provide feedback on the quality of the data distribution.

RFC 1889 specifies, among others, a “Sender Report” (or “SR”) type of RTCP packet report for transmission and reception of statistics from end points and related end terminals (“ports”) that are active packet senders.

With reference to FIG. 1, the data structure of SR packet includes:

A) an Header section 1 including, among others, the Packet Type (“PT”) code 2, the PT code for SR being “200”, and the Sender Synchronization Source Identifier (“SSRC”) data 3 identifying the port (“Sender”) originating this SR packet;

B) a Sender section 4 specifying data pertaining to said originating port, including, among others, the NTP Timestamp (“NTP”) 5 specifying the wall clock time of said originating port when this SR packet is sent; and

C) a Report section 6 that may contain zero or more reception report blocks 7.

Each reception report block 7 conveys statistics on the reception of RTP/RTCP packets from a single source (port) and includes, among others, the following data:

SSRC_n 8: identifying the port to which the data in said block pertain;

Last SR timestamp (“LSR”)9: the NTP timestamp received as part of the last SR packet received from said port SSRC_n; and

Delay since Last SR (“DLSR”)10: the delay between receiving said last SR packet and sending this SR packet.

With reference to FIG. 2, according to RFC 1889, the RTT between a port A and a port B may be measured at port A upon receiving from port B a SR packet having a reception report block referring to port A (SSRC_=A) and specifying LSR=T1 and DLSR=D1, by recording the time T2 when said SR packet is received according the wall clock of port A and by calculating RTT in accordance with the following formula:
RTT=T2−T1−D1

This RTT measuring method requires the knowledge of said time T2, and therefore it can only be implemented by an end terminal connected to said port SSRC_n or by accessing the wall clock data recorded therein. This method is not applicable in those instances in which a telecom operator or a service provider needs to monitor RTT at any point of the network different from an end point or end terminal and/or has no access to data stored therein.

Other RTT monitoring methods known in the art are based upon the computation of the RTT of artificial packets injected in the network and back forwarded to the source once received from a node or port of the network. A method of this type is implemented in the Internet Control Message Protocol (“ICMP”) described in IETF RFC 792 “Internet Control Message Protocol” issued on September 1981; it uses an artificial “echo” packet therein described.

Such artificial packet traffic methods fail to provide a measurement of the actual RTT experienced by true data packets during a communication session, because the sending and receipt of such artificial packets are asynchronous (not correlated) with respect to the true packet traffic of said session; furthermore, such methods are invasive since they increase the packet traffic of the network.

### DISCLOSURE OF THE INVENTION

An object of the present invention is to provide a method and for measuring the actual RTT in the distribution of true packets at any point of the network without creating artificial traffic in the network.

The object of the present invention is achieved by a method in which the RTT between two communicating ports is measured by detecting among the true packet traffic flowing through any point of the network a first report packet, like the aforesaid SR packet, transmitted by one of said port to the other port and a second report packet, like said SR packet, transmitted by said other port and being responsive to said first report packet and by computing said RTT as a function of the LSR data and DLSR data of said first and second packets as herein below described.

The invention also relates to a related method for managing a packet switching communication network, a corresponding system, a packet switching communication network incorporating such a system as well as a computer program product loadable in the memory of at least one computer and comprising software code portions for performing the steps of the method of the invention when the product is run on a computer. As used herein, reference to such a computer program product is intended to be equivalent to reference to a computer-readable medium containing instructions for controlling a computer system to coordinate the performance of the method of the invention. Reference to “at least one” computer is obviously intended to highlight the possibility for the arrangement of the invention to be implemented in a de-centralized fashion.

### BRIEF DESCRIPTION OF DRAWINGS

The above and other features of the present invention will be better understood from the following description of a preferred embodiment of the invention, which is intended purely by way of example and is not to be construed as limiting, taken in conjunction with the accompanying drawings, where:

FIG. 1: is schematic view of the RTCP protocol packet data structure;

FIG. 2: is a diagrammatic illustration of the flow of the RTCP packets used for the computation of the RTT in accordance with the prior-art method described in the RFC 1889;

FIG. 3 is a diagrammatic illustration of the flow of the RTCP packets used for the computation of the RTT in accordance with the method of the present invention;

FIG. 4: is a schematic block view of the system for measuring the RTT in accordance with the present invention and for managing the network communications on the basis of such RTT measurements, in accordance with the present invention;

FIG. 5: is a schematic view of the structure of a hash table of the system according to the invention; and

FIG. 6: is a flow chart describing the functional steps of the system for measuring the RTT in accordance with the present invention.

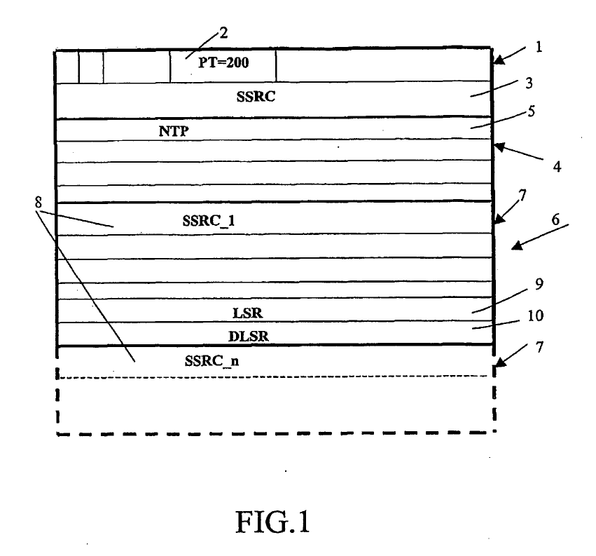

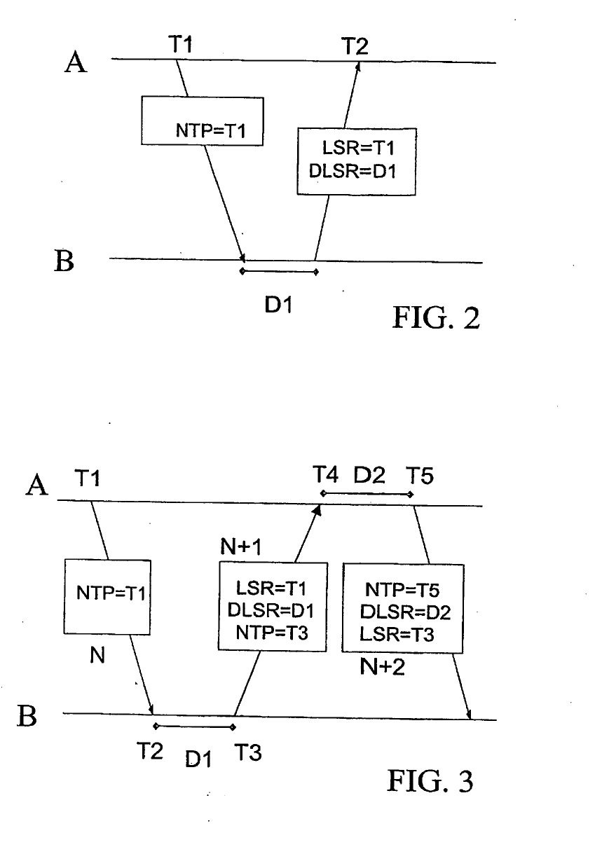

### BEST MODE FOR CARRYING OUT THE INVENTION

In the following description, for simplicity, reference is made to communications of the type in which the participating ports in a communication session are no more than two and thus the related SR packets originated by a port may have no more than one report block referring to the other communicating port identified by its source identifier SSRC1 (such communication session is some time hereinafter also referred to as “call”).

With reference to FIG. 3, during a communication session between two ports A and B of a packet switching communication network, let N be a RTCP packet sent at time T1 (NTP=T1) from the port A and received by the port B at time T2.

Let N+1 be the SR packet sent by port B at time T3 (NTP=T3), after a delay D1 from the receipt of packet N, responsive to packet N, i.e. reporting in its report block LSR=T1 and DLSR=D1 and received by port A at time T4.

Likewise, let N+2 be the SR packet sent by port A at time T5 (NTP=T5), after a delay D2 from the receipt of the SR packet N+1, responsive to the SR packet N+1, i.e. reporting in its report block LSR=T3 and DLSR=D2.

The method in accordance with the invention basically comprises the steps of:

(a) detecting among the true packet traffic flowing through a point of the network two SR packets having report blocks and being correlated like the packets N+1 and N+2 described above i.e. referring to the same communication session between two ports, the second packet (N+2) being responsive to the first packet (N+1) and thus being transmitted by the destination port of the first packet and the LSR data of the second packet being equal to the NTP data of the first SR packet; and

(b) computing the RTT as a function (the algebric sum) of the propagation delays experienced in crossing the network by said first packet (N+1) and by the previous packet (N) to which the report block of said first packet (N+1) refers, in accordance with the following formula:
RT=T5−T1−D2−D1.

It will be appreciated that the aforesaid computation is not affected by any possible lack of Synchronization between the wall clocks of ports A and B, since the data time NTP2 (T5) and LSR1 (T1) are both measured by the same wall clock (of port A in FIG. 3).

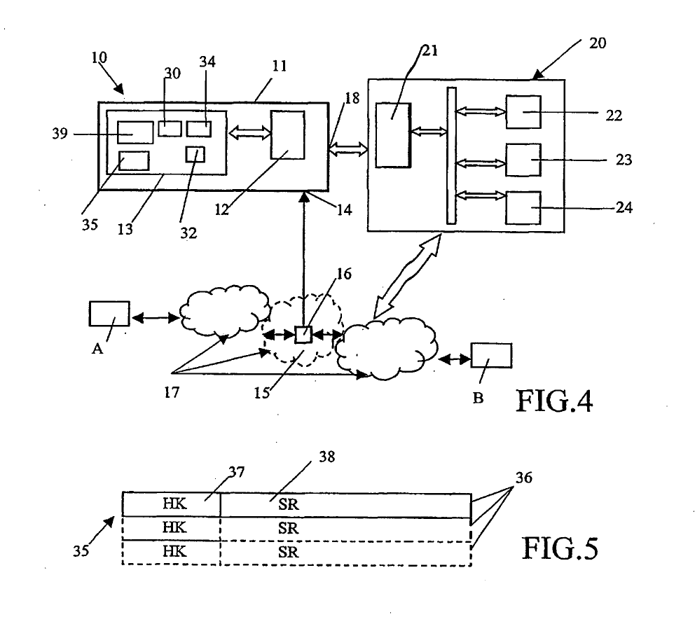

With reference to FIG. 4, the system 10 for measuring the RTT according to the invention includes a computer 11 of known type, for instance based upon Linux operating system, comprising a central processing unit. 12, a memory 13, an input port 14 connectable to any point 15 of the packet switching communication network 17 through a suitable splitter or TAP (Test Access Port) device 16 of know type, that allows capturing a copy of packet data flowing through such network point, without causing any data stream interference; the system 10 is operatively connected through its output port 18 to, and may even be considered as a subsystem of, the system 20 for managing the network comprising a Call Data Record (CDR) subsystem 21, a Billing subsystem 22, a Quality of Service (QoS) monitoring subsystem 23 and a Call Admission Control subsystem 24.

A computer program 30 of known type is loaded into the memory 12 and is suitable to run on the computer 11 for analyzing the packets captured by the device 16 and inputted into the computer 11 through port 14, selecting among them the RCTP packets and temporary storing a copy of the same in the portion 32 of the memory 12 organized to act as a first-in-first out (FIFO) buffer. Said functions of capturing, analyzing, selecting and storing packets are often referred to in the art collectively as “sniffing” packets. By way of example the sniffing computer program 30 may be the computer program known as “Tethereal” downloadable from the Internet site: http://www.ethereal.com, on Nov. 16, 2003.

Another computer program 34 is loaded into the memory 12 and is suitable to run on the computer 11 in an interoperable way with the sniffing computer program 30 for implementing the method according to the invention. The memory 12 comprises a section 35, organized under the control of the computer program 34 as a hash table (see FIG. 5) having a plurality of rows 36, where each row refers to a communication session in process between two ports of the network 17 and is suitable to store a hash key (“HK”) 37 uniquely identifying said session and the last SR packet 38 relating to said session processed by the computer program 34, as described in more details below.

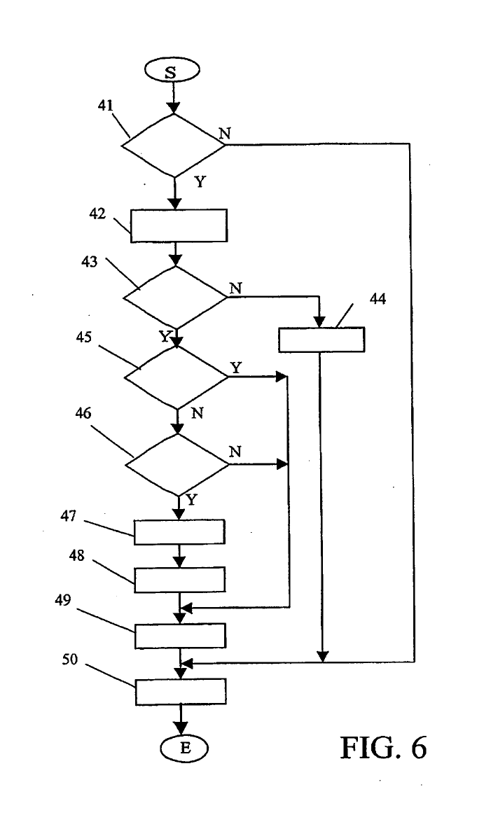

The memory 12 further comprises a section 39 organized under the control of the computer program 34 as an output file storing all the RTCP packets processed by said program 34, as described in more details below. With reference to FIG. 6, the computer program 34 is suitable to operate the computer 10 for performing the processing steps described below with respect to each RTCP packet sniffed and stored into the buffer 32 by the sniffing computer program 30. Each run of the computer program 34 starts (at S) upon receiving from the sniffing computer program 30 a coded signal that a new RTCP packet has been stored in the buffer 32 and is ready for processing (hereinafter referred to as the “packet under process”) and proceeds through the following steps:

step 41: checking if the packet under process meets all of the following conditions: is a packet of the Sender Report type, has a report block and both the LSR data and DLSR data of its report block are different from zero, and in the negative case skipping to step 50; while in the affirmative case proceeding with step 42;

step 42: computing the hash key 37 for the packet under process; by way of example, the algorithm for computing said key provides for ordering by increasing values the SSRC of the Sender and the SSRC of the (first) source SSRC1 reported by the packet under process and by prepending the lower SSRC value to the higher SSRC value;

step 43: checking if the packet under process refers to a communication session for which a SR packet is already stored in the hash table 35 (hereinafter referred to as the “previous packet”), by comparing the hash key 37 computed in step 42 with each of the hash keys 37 stored in the hash table 35, and in the negative case continuing with step 44, while in the affirmative case skipping to step 45;

step 44: creating a new row 36 in the hash table 35, storing the SR packet under process in association with its related hash key 37 in said new row 36 and then skipping to step 50;

step 45: checking if said previous packet was originated by the same port of the packet under process i.e. checking whether the Sender SSRC of the previous packet is equal to the Sender SSRC of the packet under process and in the affirmative case skipping to step 49, while in the negative case continuing with step 46;

step 46: checking if the NPT of said previous packet is equal to LSR reported by the packet under process and in the negative case skipping to step 49, while in the affirmative case proceeding with step 47; it will be appreciated that in such affirmative case said previous packet and the packet under process are correlated in the same way as the packet N+1 and respectively N+2 of FIG. 3 above described;

step 47: computing the RTT in accordance with the following formula:
RTT=NTP2−LSR1−DLSR2−DLSR1

where:

NTP2 is the NTP time data of the packet under process (like the aforesaid (N+2) packet);

LSR1 is the LSR time data in the report block of said previous packet (like the aforesaid (N+1) packet);

DLSR1 is the DLSR delay data in the report block of said previous packet; and

DLSR2 is the DLSR delay data in the report block of the packet under process(N+2);

step 48: creating a new data field in the report block of the packet under process and storing therein the computed RTT value;

step 49: storing the packet under process (enriched with the computed RTT value, in case the steps 47 and 48 have been performed) in the hash table 35 in substitution of said previous packet;

step 50: storing the packet under process in the output file 39 and then ending run (at E).

The SR packets stored in the output file 39, enriched with the computed RTT values as aforesaid, are accessible by the network management system 20 for operating and managing the network and the communication services rendered thereby, including, by way of example and without limitation, for performing one or more of the following functions:

(a) associating to the Call Data Record (CDR) of each communication session (or “call”) in the CDR subsystem 21 the corresponding RTCP data of the output file 39, so enriching such CDR with data pertaining to the quality of the related call;

(b) processing, by the QoS monitoring subsystem 23, the RTCP data associated to the CDR files under (a) above, both on a per call basis and on an average statistical basis, to compute QoS data and other network performance and quality data (collectively “network behaviour related data”) and, if such computed data fail to meet or exceed predetermined reference values pre-recorded in the QoS monitoring subsystem 23, to trigger network planning actions or other remedial actions suitable to improve performance and quality of communication services;

(c) processing, by the Billing subsystem 22, the RTCP data associated to the CDR files under (a) above for pricing and billing to the related customer each call on the basis the actual level of quality experienced for such call; e.g. (i) computing, on the basis of said RTCP data, an actual level of quality value associated with each call (it may also be the network behaviour related data for said call computed under (b) above by the QoS Monitoring Subsystem 23), (ii) comparing whether said actual level of quality value is less than that contractually provided for said customer as pre-recorded in the Billing subsystem and (iii) in the affirmative case, discounting the pre-recorded contractual price applicable to said customer of an amount directly related to the difference between said prescribed value and said actual value of quality level;

(d) processing, by the Call Admission Control subsystem 24, the RTCP data and computing data representatives of the actual network traffic and congestion conditions and, on the basis of the same, automatically controlling the admission in the network of new communication sessions or the dropping of communication sessions in progress.

It will be appreciated that any of the functional steps under (b) (c) or (d) above may include, in particular, the steps of processing the RTT of any call, measured in accordance with the present invention, as part of the aforesaid computing steps and/or of checking if said measured RTT exceeds a predetermined value stored in the network management system 20 and, in the affirmative case, triggering a remedial action or providing an alerting signal.

Obvious modifications or variations are possible to the above description, in the components, circuit elements, logical elements, connections and contacts, as well as in the details of the flow charts, circuitry, functionality, method steps, protocols, packet format and structure and method of operation, without thereby departing from the scope of the invention as specified in the claims that follow.

1-31. (canceled)

32. A method of measuring round trip time (RTT) in communication of packets between ports of a packet switching communication network in which, among other packets, report packets are transmitted by transmitting ports to destination ports in response to previous packets received from said respective destination ports, any of said report packets reporting at least the following data: (i) identification code of the transmitting port; (ii) identification code of the destination port; (iii) report packet transmission time; (iv) previous packet transmission time; and (v) delay between receiving said previous packet and transmitting said responsive report packet, comprising the steps of:
(a) detecting at any point of the network, among the packet traffic flowing therethrough, a first report packet transmitted by a first port to a second port and a second report packet responsive to said first report packet; and
(b) computing the round trip time between said first and second ports as a function of the report packet transmission time and delay data reported in said second report packet and of the previous report transmission time and delay data reported in said first report packet.

33. The method in accordance with claim 32 wherein said round trip time (RTT) between said first and second ports is computed in accordance with the following equation:
RTT=NTP2−LSR1−DLSR1−DLSR2
where
NTP2 is the report packet transmission time reported in said second report packet;
LSR1 is the previous packet transmission time reported in said first report packet;
DLSR1 is the delay reported in said first report packet; and
DLSR2 is the delay reported in said second report packet.

34. The method in accordance with claim 32, further comprising the additional step of:
(c) including the computed RTT value as additional data of said second report packet.

35. The method in accordance with claim 32, wherein said detecting step (a) comprises the following steps:
(a1) detecting each report packet flowing through said point of the network;
(a2) checking if a newly detected report packet relates to the same communication between two ports of a previously detected report packet;
(a3) if the check under step (a2) is negative, storing said newly detected report packet; and
(a4) if the check under step (a2) is affirmative, checking if said newly detected report packet is responsive to said previously detected report packet.

36. The method in accordance with claim 35, wherein said detecting step (a) further comprises the following step:
(a5) if the check under step (a2) is affirmative and said newly detected report packet is transmitted by the same port of said previously detected report packet, storing said newly detected report packet in substitution of said previously detected report packet.

37. The method in accordance with claim 35, wherein said checking step (a2) comprises associating to each newly detected report packet a key uniquely identifying the communication session between the two ports to which said newly detected report packet relates; and comparing said key with each of the keys associated with previously detected and stored report packets.

38. The method in accordance with claim 35, wherein said checking step (a4) comprises checking if the transmission time of said previously detected report packet is equal to the previous report transmission time of said newly detected report packet.

39. The method in accordance with claim 35, comprising the following additional steps:
(c) including the computed RTT value as additional data of said second report packet; and
(d) storing said second record packet including said computed RTT value in substitution of said previously detected report packet.

40. The method in accordance with claim 32, wherein said report packet detecting step (a) comprises the step of sniffing packets flowing through said network point.

41. A method of managing a packet switching communication network in which, among other packets, report packets are transmitted by transmitting ports to destination ports in response to previous packets received from said respective destination ports, any of said report packets reporting at least the following data: (i) identification code of the transmitting port; (ii) identification code of the destination port; (iii) report packet transmission time; (iv) previous packet transmission time; (v) delay between receiving said previous packet and transmitting said responsive report packet, comprising the steps of:
measuring the round trip time (RTT) between communicating ports of said network in accordance with the method of claim 32; and
managing the network on the basis of computed RTT data.

42. The method in accordance with claim 41 wherein said managing step comprises checking if said measured RTT data exceeds a predetermined value; and in the affirmative case, generating a coded signal.

43. The method in accordance with claim 41, wherein said managing step comprises associating said RTT computed data to a call data record of the communication session to which said data relate.

44. The method in accordance with claim 43, wherein said managing step comprises:
computing network behaviour related data on the basis of said RTT data;
checking if network behaviour related data fail to meet predetermined reference data; and, in the negative case,
triggering a remedial action.

45. The method in accordance with claim 44, wherein said remedial action comprises discounting the price of a communication session for which said network behaviour related data fail to meet said predetermined reference data.

46. The method in accordance with claim 44, wherein said remedial action comprises a network-planning action.

47. The method in accordance with claim 44, wherein said remedial action comprises dropping a communication session.

48. The method in accordance with claim 44, wherein said remedial action comprises temporary inhibiting admission of a further communication session.

49. The method in accordance with claim 32, wherein any of said report packet is an RTCP packet of the sender report type with report block, in accordance with internet real-time control protocol.

50. A system for measuring round trip time (RTT) in communication of packets between ports of a packet switching communication network in which, among other packets, report packets are transmitted by transmitting ports to destination ports in response to previous packets received from said respective destination ports, any of said report packets reporting at least the following data: (i) identification code of the transmitting port; (ii) identification code of the destination port; (iii) report packet transmission time; (iv) previous packet transmission time; and (v) delay between receiving said previous packet and transmitting said responsive report packet, comprising a sniffer operatively connectable at any point of said network, for sniffing packets flowing therethrough, a memory for selectively storing sniffed packets; and comprising a processor sufficient to:
(a) process the sniffed packets so as to identify, among the packet traffic flowing therethrough, a first report packet transmitted by a first port to a second port and a second report packet responsive to said first report packet; and
(b) compute the round trip time between said first and second ports as a function of the report packet transmission time and delay data reported in said second report packet and of the previous report transmission time and delay data reported in said first report packet.

51. A system for managing a packet switching communication network, in which among other packets, report packets are transmitted by transmitting ports to destination ports in response to previous packets received from said respective destination ports, any of said report packet reporting at least the following data: (i) identification code of the transmitting port; (ii) identification code of the destination port; (iii) report packet transmission time; (iv) previous packet transmission time; and (v) delay between receiving said previous packet and transmitting said responsive report packet, comprising a round trip time (RTT) measuring subsystem and at least a network management subsystem for processing RTT data measured by said RTT measuring system, said RTT measuring subsystem being suitable to:
(a) detect at any point of the network, among the packet traffic flowing therethrough, a first report packet transmitted by a first port to a second port and a second report packet responsive to said first report packet; and
(b) compute the round trip time between said first and second ports as a function of the report packet transmission time and delay data reported in said second report packet and of the previous report transmission time and delay data reported in said first report packet.

52. The system in accordance with claim 51, wherein said network management subsystem is suitable to check if the round trip time measured by said measuring subsystem exceeds a predetermined value and, in the affirmative case, to generate a coded signal.

53. The system in accordance with claim 51, further comprising a call detail record subsystem for recording call detail data relating to each communication session and for associating to said call detail data the RTT data measured by said RTT measuring system included in said report packets and relating to the same communication session.

54. The system in accordance with claim 51, wherein said network management subsystem is suitable to compute network behaviour related data on the basis of said measured RTT data to check if said computed network behaviour related data fail to meet predetermined reference data and, in the negative case, to trigger a remedial action.

55. The system in accordance with claim 54 wherein said triggered action comprises discounting the price of a communication session for which said network behaviour related data fail to meet said predetermined reference data.

56. The system in accordance with claim 54 wherein said triggered action comprises a network planning action.

57. The system in accordance with claim 54, wherein said triggered action comprises dropping a communication session for which said network behaviour related data fail to meet said predetermined reference data.

58. The system in accordance with claim 54, wherein said triggered action comprises temporary inhibiting admission of a further communication session.

59. The system in accordance with claim 51, wherein any of said report packets is an RTCP packet of the sender report type with report block, in accordance with internet real-time control protocol.

60. A packet switching communication network including at least two nodes linked by a communication link and a managing system according to any one of claims 51-59.

61. A computer program product loadable in the memory of at least one computer and comprising a software code portion capable of performing the method of any one of claims 32-49.

62. A packet switching communication network managed in accordance with the method of claim 41.
